(19) United States
(12) Patent Application Publication
(10) Pub. No.: US 2026/0140054 A1
(43) Pub. Date: May 21, 2026

(54) SPECTRUM DETECTION SYSTEM

(71) Applicant: Jiangsu Dualix Spectral Imaging Technology Co., Ltd., Wuxi (CN)

(72) Inventors: Xinghai CHEN, Wuxi (CN); Hongtai CAI, Wuxi (CN); Guangli SHI, Wuxi (CN); Wenjuan PENG, Wuxi (CN); Jiabao CAO, Wuxi (CN)

(73) Assignee: Jiangsu Dualix Spectral Imaging Technology Co., Ltd., Wuxi (CN)

(21) Appl. No.: 19/369,098

(22) Filed: Oct. 24, 2025

(30) Foreign Application Priority Data
Nov. 15, 2024 (CN) 202411630574.7

(51) Int. Cl. G01N 21/64; G01N 21/31

(52) U.S. Cl. CPC G01N 21/6402; G01N 21/31; G01N 2201/0633; G01N 2201/0636

(57) ABSTRACT

A spectrum detection system includes a sample cell, a slit, a disperser, and an area array detector. Laser light from a sample passes through the slit, the disperser, and the area array detector in sequence. The disperser is configured to diffract and disperse light at different wavelengths. The present application greatly improves the excitation and signal detection capabilities for the sample by adopting a line-excitation and line-collection method by utilizing line transmission characteristics of the laser light and weak absorption and scattering characteristics of the laser light by gases and liquids, and utilizing slit imaging characteristics of an imaging spectrometer.

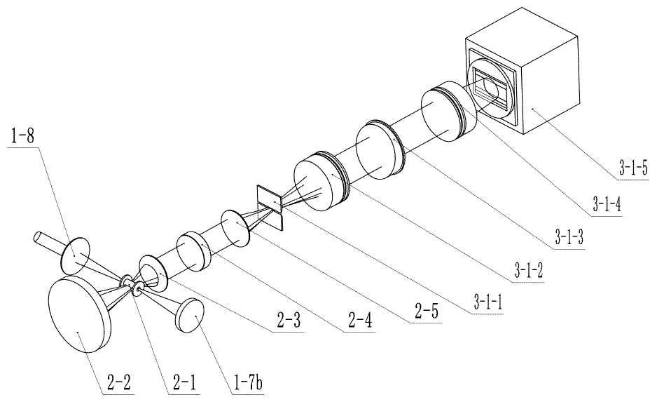

### CROSS-REFERENCE TO RELATED APPLICATIONS

This application claims priority to Chinese Patent Application No. 202411630574.7, filed on Nov. 15, 2024, the content of which is incorporated herein by reference in its entirety.

### TECHNICAL FIELD

The present application relates to the technical field of spectrum detection, and in particular to a spectrum detection system.

### BACKGROUND

With the continuous development of laser technologies, Raman and fluorescence detection technologies with laser light as an excitation source and application ranges thereof are becoming increasingly wider. Various detection objects are possible in practical applications, including solids, liquids, and gases, all of which can be detected for Raman and fluorescence signals by using laser light as an excitation source.

Conventional Raman and fluorescence detection systems mostly use a point-excitation and point-collection testing method. That is, the laser light is focused onto a sample to be tested, and then the fluorescence or scattering (Raman or Rayleigh) signals generated by excitation of laser points on the sample are collected through a collection optical path to a spectral signal measurement apparatus for detection. The collection optical paths of existing laser excitation Raman and fluorescence spectrum testing systems are applicable to non-transparent testing samples such as solid and powder samples. However, for transparent substances such as gases and liquids, the absorption and scattering cross-sections for excitation light are small, and the excited fluorescence or Raman signals are weak, resulting in low collection efficiency.

In view of this, there is an urgent need for a spectrum detection system.

### SUMMARY

In view of the problems in the prior art, the present application uses the following technical structure to solve the problems.

In order to realize the above objective, the present application adopts the following technical solutions.

A spectrum detection system includes a sample cell, a slit, a disperser, and an area array detector, where laser light from a sample passes through the slit, the disperser, and the area array detector in sequence; and the disperser is configured to diffract and disperse light at different wavelengths.

Further, a first collimating lens configured to collimate the laser light from the slit is disposed between the slit and the disperser.

A first focusing lens is disposed between the disperser and the area array detector.

The slit, the first collimating lens, the disperser, and the area array detector are distributed in a straight line.

A collection mirror configured to collect scattering or fluorescence signals generated by the sample is disposed on a side of the sample cell distal to the slit.

A second collimating lens is disposed between the sample cell and the slit.

A laser filter is disposed between the second collimating lens and the slit.

A second focusing lens is disposed between the laser filter and the slit.

The collection mirror, the second collimating lens, the laser filter, the second focusing lens, and the slit are distributed in a straight line.

A slit plate is disposed between the second focusing lens and the first collimating lens, and the slit is formed on the slit plate.

The above structure of the present application can achieve the following beneficial effects:

The present application greatly improves the excitation and signal detection capabilities for the sample by adopting a line-excitation and line-collection method by utilizing line transmission characteristics of the laser light and weak absorption and scattering characteristics of the laser light by gases and liquids, and utilizing slit imaging characteristics of an imaging spectrometer.

### BRIEF DESCRIPTION OF THE DRAWINGS

The accompanying figure is a structural schematic diagram according to an embodiment.

### DETAILED DESCRIPTION OF THE EMBODIMENTS

To enable those skilled in the art to better understand the solutions of the present application, the technical solutions in the embodiments of the present application will be clearly and completely described hereinafter in conjunction with the accompanying drawings in the embodiments of the present application. Apparently, the described embodiments are merely part, rather than all of embodiments of the present application. Based on the embodiments of the present application, all other embodiments obtained by those of ordinary skill in the art without creative effort shall fall within the protection scope of the present application.

It should be noted that the terms “comprise/include” and “have” in the specification, claims, and the above accompanying drawings of the present application, as well as any variations thereof, are intended to cover non-exclusive inclusion. For example, a process, method, device, product, or apparatus that includes a series of steps or units is not necessarily limited to those steps or units explicitly listed but may include additional steps or units not expressly listed or inherent to such process, method, product, or apparatus.

The present application is further described in detail hereinafter with reference to the accompanying figure.

Referring to the accompanying figure, a spectrum detection system includes: a sample cell 2-1, a slit 3-1-1, a first collimating lens 3-1-2, a disperser 3-1-3, a first focusing lens 3-1-4, and an area array detector 3-1-5. The slit 3-1-1, the first collimating lens 3-1-2, the disperser 3-1-3, the first focusing lens 3-1-4, and the area array detector 3-1-5 are distributed in a straight line. Laser light from a sample passes through the slit 3-1-1, the first collimating lens 3-1-2, the disperser 3-1-3, the first focusing lens 3-1-4, and the area array detector 3-1-5 in sequence. Signal light from the sample cell 2-1 is focused to the slit 3-1-1, then collimated by the first collimating lens 3-1-2, and then subjected to diffraction and dispersion for light at different wavelengths by the disperser 3-1-3 before the first focusing lens 3-1-4 focuses the signal light at different wavelengths to the Y direction of the area array detector 3-1-5. The Y direction of the area array detector 3-1-5 corresponds to signals at different wavelengths, and the X direction corresponds to spatial dimension information in the length direction of the slit 3-1-1. That is, each column of the area array detector 3-1-5 corresponds to spectral information of a point in the length direction of the slit 3-1-1. By accumulating and integrating the detector signals in the X direction (accumulating the signals in the X direction, i.e., corresponding to the length direction of the slit 3-1-1, to implement integral enhancement), line integral detection can be implemented on scattering or fluorescence signals generated by line excitation by the laser light, thereby improving signal intensity and detection sensitivity. Alternatively, each point can be detected separately to implement line imaging and counting detection of signals along the excitation line, which is applicable to applications such as detection of microplastics in solution, particles in gases, or abnormal cells in blood.

As shown in the accompanying figure, the embodiment further includes a collection mirror 2-2 configured to collect the scattering or fluorescence signals generated by the sample, a collimating lens 2-3 configured to collimate the scattering or fluorescence signals collected by the collection mirror 2-2, a laser filter 2-4, and a second focusing lens 2-5. The collection mirror 2-2, the second collimating lens 2-3, the laser filter 2-4, the second focusing lens 2-5, and the slit 3-1-1 are distributed in a straight line. The collimated laser light passes through the laser filter 2-4 and enters the spectrum detection unit 3. The second focusing lens 2-5 focuses the laser light entering the spectrum detection unit 3. The scattering or fluorescence signals generated by excitation of the gas or liquid sample in the sample cell 2-1 by the laser light are collected and collimated by the collection mirror 2-2 and the collimating lens 2-3 and then pass through the laser filter 2-4 to filter out excitation light before the second focusing lens 2-5 focuses the signal light to the spectrum detection unit 3.

Further optimized, a slit plate is disposed between the second focusing lens 2-5 and the first collimating lens 3-1-2, and the slit 3-1-1 is formed on the slit plate.

In summary, the present application greatly improves the excitation and signal detection capabilities for the sample by adopting a line-excitation and line-collection method by utilizing line transmission characteristics of the laser light and weak absorption and scattering characteristics of the laser light by gases and liquids, and utilizing slit imaging characteristics of an imaging spectrometer. The present application is applicable to both non-transparent testing samples such as solid and powder samples, and transparent substances such as gases and liquids.

The above are only preferred implementations of the present application, and the present application is not limited to the above embodiments. It should be understood that other modifications and variations directly derived or conceived by those skilled in the art without departing from the spirit and concept of the present application shall be considered as falling within the protection scope of the present application.

What is claimed is:

1. A spectrum detection system, comprising: a sample cell, a slit, a disperser, and an area array detector,
wherein laser light from a sample passes through the slit, the disperser, and the area array detector in sequence; and
the disperser is configured to diffract and disperse light at different wavelengths.

2. The spectrum detection system according to claim 1, wherein a first collimating lens configured to collimate the laser light from the slit is disposed between the slit and the disperser.

3. The spectrum detection system according to claim 2, wherein a first focusing lens is disposed between the disperser and the area array detector.

4. The spectrum detection system according to claim 3, wherein the slit, the first collimating lens, the disperser, and the area array detector are distributed in a straight line.

5. The spectrum detection system according to claim 1, wherein a collection mirror configured to collect scattering or fluorescence signals generated by the sample is disposed on a side of a sample cell distal to the slit.

6. The spectrum detection system according to claim 5, wherein a second collimating lens is disposed between the sample cell and the slit.

7. The spectrum detection system according to claim 6, wherein a laser filter is disposed between the second collimating lens and the slit.

8. The spectrum detection system according to claim 7, wherein a second focusing lens is disposed between the laser filter and the slit.

9. The spectrum detection system according to claim 8, wherein the collection mirror, the second collimating lens, the laser filter, the second focusing lens, and the slit are distributed in a straight line.

10. The spectrum detection system according to claim 8, wherein a slit plate is disposed between the second focusing lens and the first collimating lens, and the slit is formed on the slit plate.
